(19) United States
(12) Patent Application Publication
(10) Pub. No.: US 2003/0012580 A1
(43) Pub. Date: Jan. 16, 2003

(54) Developing apparatus provided with seal functions on both sides of developing roller

(75) Inventor: Shigeo Miyabe, Shizuoka (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 10/084,457

(22) Filed: Feb. 28, 2002

(30) Foreign Application Priority Data
Mar. 1, 2001 (JP) 056572/2001(PAT.)

(51) Int. Cl. G03G 15/08

(52) U.S. Cl. 399/103; 399/104

(57) ABSTRACT

The developing apparatus has a rotatable developer bearing member, a bearing member for holding the developer bearing member rotatably, and a seal member for preventing a leakage of a developer from an end portion of the developer bearing member in a lengthwise direction thereof to the lengthwise direction. In the developing apparatus, the seal member is located by the bearing member.

### BACKGROUND OF THE INVENTION

1. Field of the Invention

The present invention relates to a developing apparatus to be mounted in an image forming apparatus, which uses a recording technique such as an electrophotographic process, an electrostatic recording process or the like, like a copying machine, a printer and the like. In particular, the present invention relates to a developing apparatus suitable for being mounted in a process cartridge capable of being detachably attachable to an image forming apparatus.

2. Related Art

An image forming apparatus using an electrophotography requires its maintenance such as the exchange of its photosensitive body drum, the replenishment or the exchange of its developer, the adjustment, the cleaning or the exchange of its other parts (its charger, its cleaner container or the like) when the image forming apparatus has been used for a long time. It is practically difficult for a person other than a serviceperson having an expert knowledge to do such maintenance work.

Accordingly, an image forming apparatus employing an electrophotographic image forming process has employed a process cartridge system in which an electrophotographic photosensitive body and process means working on the electrophotographic photosensitive body are integrally formed to be a cartridge and the cartridge is made to be detachably attachable to the main body of the image forming apparatus. Because the process cartridge system enables a user to perform the maintenance of the apparatus by himself or herself without relying on a serviceperson, the process cartridge system has been abler to improve the operability of the image forming apparatus remarkably. Consequently, the process cartridge system is widely used in the image forming apparatus.

Thereby, when the maintenance of an aforesaid process device becomes necessary, a user himself or herself can simply maintain or exchange a process cartridge, and consequently, it has become able to obtain a high grade image quality cheaply and easily.

Developing means (or a developing apparatus) built in such a process cartridge is provided with seal members for preventing the outflow of toner to an area other than the developing area at both end portions of a developer bearing body such as a rotating developing roller mounted in the developing apparatus. An elastic body made of a felt, a expanded rubber or the like is widely used as a conventional seal member preventing the outflow of toner.

A developing roller is provided with a magnet roller therein, and is rotatably supported by a developing container with sleeve bearings. Consequently, toner fed from the developing container attaches to the surface of the developing roller by a magnetic force of the magnet roller. After the thickness of the attached toner layer has been regulated by a developing blade, the toner attaches to a latent image on a photosensitive drum at a position opposed to the latent image on the photosensitive drum as the developing roller rotates. Consequently, the latent image is developed.

The developing apparatus is further provided with elastic seal members attached at both end portions of the developing roller at the outsides of the developing area in the lengthwise direction thereof and at the inner part on the side opposite to the opening side of the developing roller attached to a developing frame body of the developing apparatus. The elastic seal member is pressed to the outer peripheral surface of the developing roller for preventing the outflow of toner.

As for the aforesaid contact type seal members, because the elastic seals are pressed to the half of the outer peripheral surface of the developing roller, the conventional developing apparatus has the problem such that the load of the developing roller, which rotates at the time of a developing operation, is large, and the problem such that the elastic seal members deteriorate owing to the contact with the developing roller to make the sealing performance of the elastic seal members worse. Moreover, toner sometimes enters into the gaps between the developing roller and the elastic seal members though the amount of the entered toner is a little. The invasion of the toner sometimes caused the increase of torque or the increase of fluctuations of torque to produce the unevenness of the rotations of the developing roller. And then, a bad influence was sometimes exerted upon image formation.

Accordingly, for solving those problems, a noncontact type seal member has been proposed. In the noncontact type seal member, seal members made of a magnetic body (hereinafter referred to as “magnetic seals”) are disposed at both end portions of the developing roller with predetermined spaces between them for preventing the outflow of toner.

The magnetic seal is made of a magnet. The magnetic seals are attached to both the end portions of the developing roller in the state of being wound around the end portions for being disposed with a predetermined gap (about 0.1 mm to 0.7 mm) to the outer peripheral surface of the developing roller. The magnetic seals are attached to the developing container in the wounded state along with the developing roller. The surfaces of the magnetic seals opposed to the developing roller are magnetized. Magnetic brushes formed by chained toner formed along each line of magnetic forces fill up the gaps between the outer peripheral surface of the developing roller and the surfaces of the magnetic seals to prevent the outflow of toner from the developing area.

Moreover, because it is needed to locate the magnetic seals highly precisely to the developing roller, various locating methods have conventionally been devised.

Incidentally, in both cases of the use of the aforesaid contact type seal member and the use of the noncontact type seal member, high accuracy of the attachment of them to the main body of the developing apparatus is required for securing their seal performances.

### SUMMARY OF THE INVENTION

The present invention was made in consideration of the aforesaid problems, and an object of the invention is to provide a developing apparatus in which toner does not easily leak out.

Another object of the invention is to provide a developing apparatus in which seal members for preventing the leak out of toner from the end portions of its developing roller can be attached highly accurately.

A further object of the invention is to provide a developing member to which seal members for preventing the leakage of toner from the end portions of its developing roller can be attached simply and accurately.

A still further object of the invention is to provide a developing apparatus in which the positional accuracy of seal members to its developing roller is high.

A still further object of the invention is to provide a developing apparatus including a rotatable developer bearing member, a bearing member for holding the developer bearing member rotatably, and a seal member for preventing the leakage of a developer from an end portion of the developer bearing member in the lengthwise direction thereof into the lengthwise direction, wherein the seal member is located by the bearing member.

The still further object of the invention will be more apparent from the following detailed description taken in conjunction with the accompanying drawings.

### BRIEF DESCRIPTION OF THE DRAWINGS

FIG. 1 is a schematic diagram of the principal section of a process cartridge according to an embodiment of the present invention;

FIG. 2 is a schematic diagram of the principal section of the apparatus main body according to the embodiment of the invention;

FIG. 3 is a side elevation showing the process cartridge of the embodiment of the invention seen from a side face thereof;

FIG. 4 is a side elevation showing the process cartridge of the embodiment of the invention seen from another side face thereof;

FIG. 5 is a perspective view of the process cartridge in the embodiment of the invention;

FIG. 6 is another perspective view of the process cartridge in the embodiment of the invention;

FIG. 7 is a disassembled perspective view of a process cartridge frame body in the embodiment of the invention;

FIG. 8 is a front view of a developing apparatus;

FIG. 9 is a sectional view of the developing apparatus taken along IX-IX line in FIG. 8;

FIG. 10 is a sectional view of the developing apparatus taken along X-X line in FIG. 9;

FIG. 11 is a sectional view of the developing apparatus taken along XI-XI line in FIG. 8;

FIG. 12 is a perspective view showing a state of each part of the developing apparatus before they are assembled;

FIG. 13 is a perspective view of a simplex magnetic seal;

FIG. 14 is a perspective view showing only a developing bearing frame body and a developing frame body before they are assembled;

FIG. 15 is a perspective view of another embodiment of the developing bearing frame body;

FIG. 16 is a perspective view showing only a developing roller and a magnetic seal; and

FIG. 17A is a sectional view of the developing roller and the magnetic seal taken along an XVII-XVII line in FIG. 16, and FIG. 17B is a macrograph of the part of 17B in FIG. 17A.

### DESCRIPTION OF THE PREFERRED EMBODIMENTS

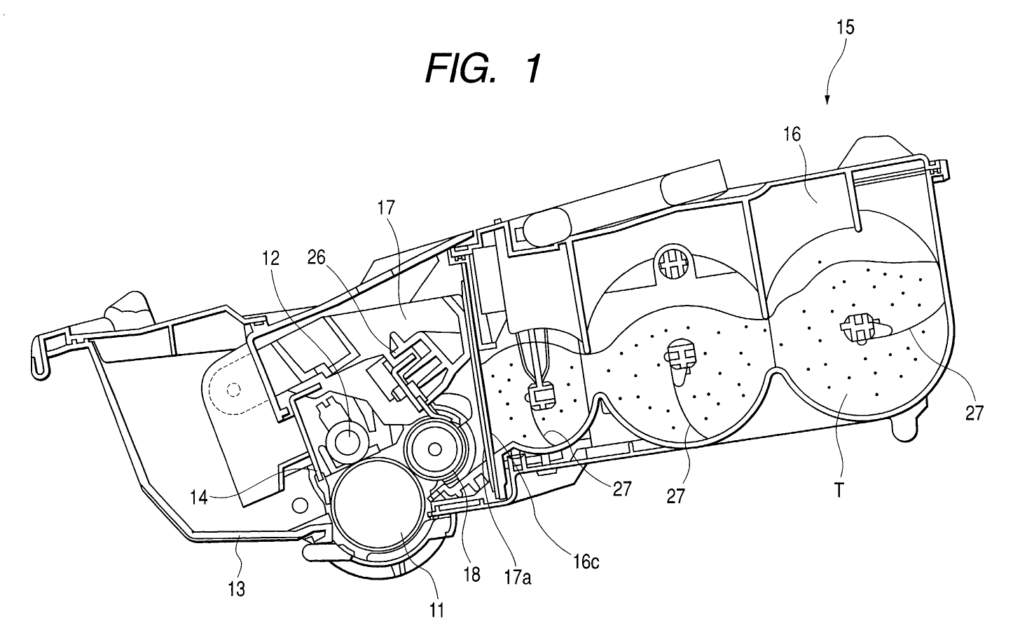

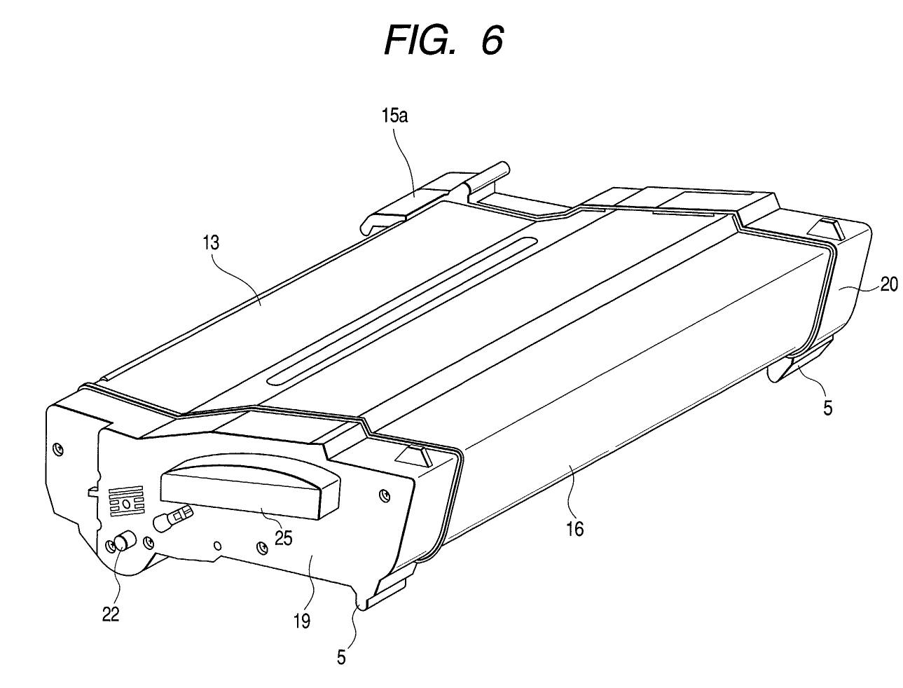

FIG. 1 to FIG. 17B are referred while an preferred embodiment of the present invention is described.

(Description of Process Cartridge and Apparatus Main Body)

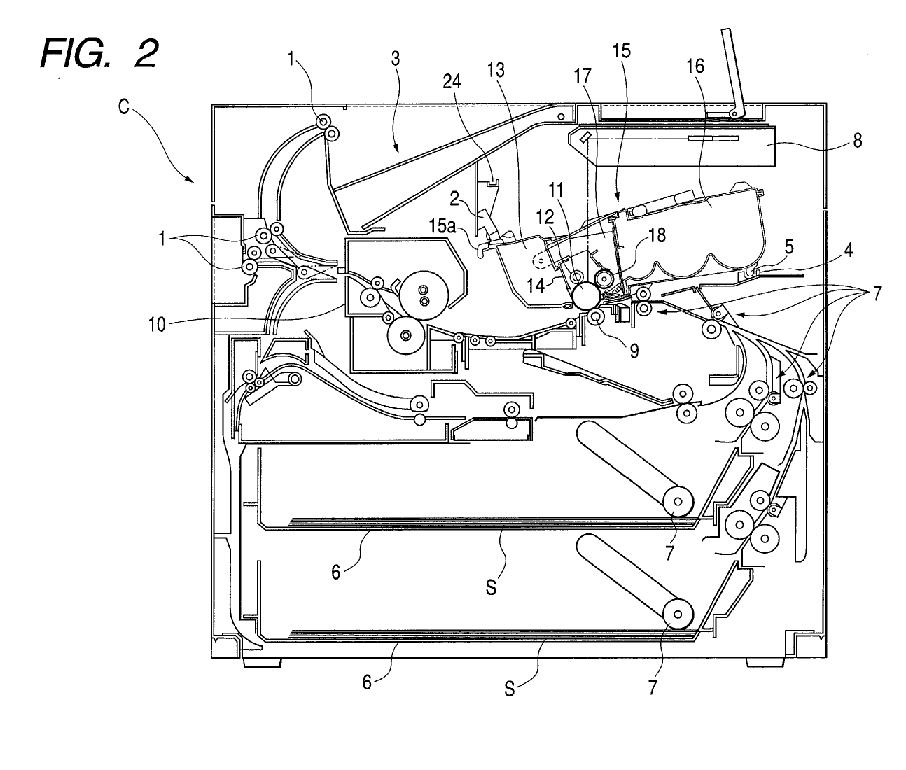

FIG. 1 is a diagram of the principal section of a process cartridge according to the present invention, and FIG. 2 is a diagram of the principal section of an image forming apparatus according to the invention. The process cartridge is equipped with an image bearing body and process means working on the image bearing body. The process means includes, for example, charging means for charging the surface of the image bearing body, a developing apparatus for forming a toner image on the image bearing body, and cleaning means for removing the toner remaining on the surface of the image bearing body.

The process cartridge 15 of the present embodiment disposes, as shown in FIG. 1, a charging roller 12 being the charging means; a developing roller 18, a developing blade 26 and a toner containing frame body 16 for containing toner as the developing means; and a cleaning blade 14 as the cleaning means around the electrophotographic photosensitive body drum (hereinafter referred to as a “photosensitive body drum”) 11 being the image bearing body. Each component is integrally covered by a housing to be the process cartridge 15. The process cartridge 15 is configured to be detachably attachable to an image forming apparatus main body C.

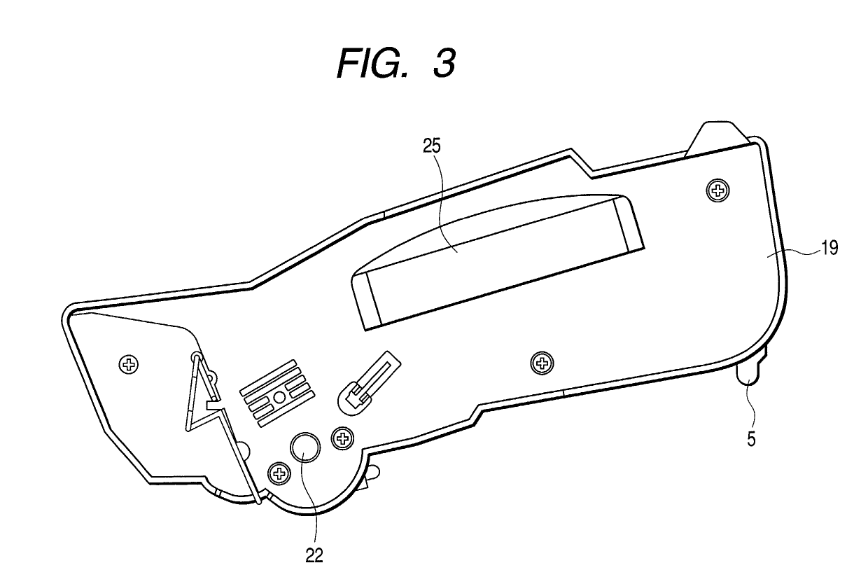

FIG. 2 shows the image forming apparatus in the state capable of forming an image after the process cartridge 15 has been mounted in the apparatus main body C. The process cartridge 15 can be detached from the apparatus main body C in conformity with the following procedures. That is: at first, a hoist arm 2 capable of supporting the left side end portion of the process cartridge 15 is raised with a not shown handle to swing the process cartridge 15 on a guide rail 24 of the apparatus main body C around a fulcrum foot 5 of the process cartridge 15; a guide portion 15a of the process cartridge 15 is thereby made to accord with a guide rail 24 of the apparatus main body C; and then the process cartridge 15 is pulled out toward the front side of FIG. 1 by a user, being gripped by the user's hand on a handle 25 (see FIG. 3).

The attachment of the process cartridge 15 to the apparatus main body C is performed in conformity with the reverse procedures of the procedures at the detachment thereof described above.

The process cartridge 15 is used for image formation in the state of being mounted in the apparatus main body C shown in FIG. 2. The image formation is performed in conformity with the following procedures. That is, at first, a sheet S as a recording medium is conveyed from sheet cassettes 6 mounted at the lower part of the apparatus with conveying rollers 7, and an exposing apparatus 8 selectively exposes the photosensitive body drum 11, which has uniformly been charged by the charging roller 12, to light synchronously with the sheet conveyance for forming a latent image. After that, toner contained in the toner containing frame body 16 is carried toward the developing roller 18, and a thin toner layer is borne on the surface of the developing roller 18 with the developing blade 26. And then, a developing bias is applied to the developing roller 18 to feed toner on the surface of the photosensitive body drum 11 according to the latent image. The toner image on the photosensitive body drum 11 is then transferred to the conveyed sheet S by the application of a bias voltage to a transferring roller 9. The sheet S is conveyed to a fixing apparatus 10, and the toner image transferred on the sheet S is fixed by the fixing apparatus 10. Then, the sheet S is delivered to a discharging portion 3 at the upper part of the apparatus by discharging rollers 1.

(Frame Body Configuration of Process Cartridge)

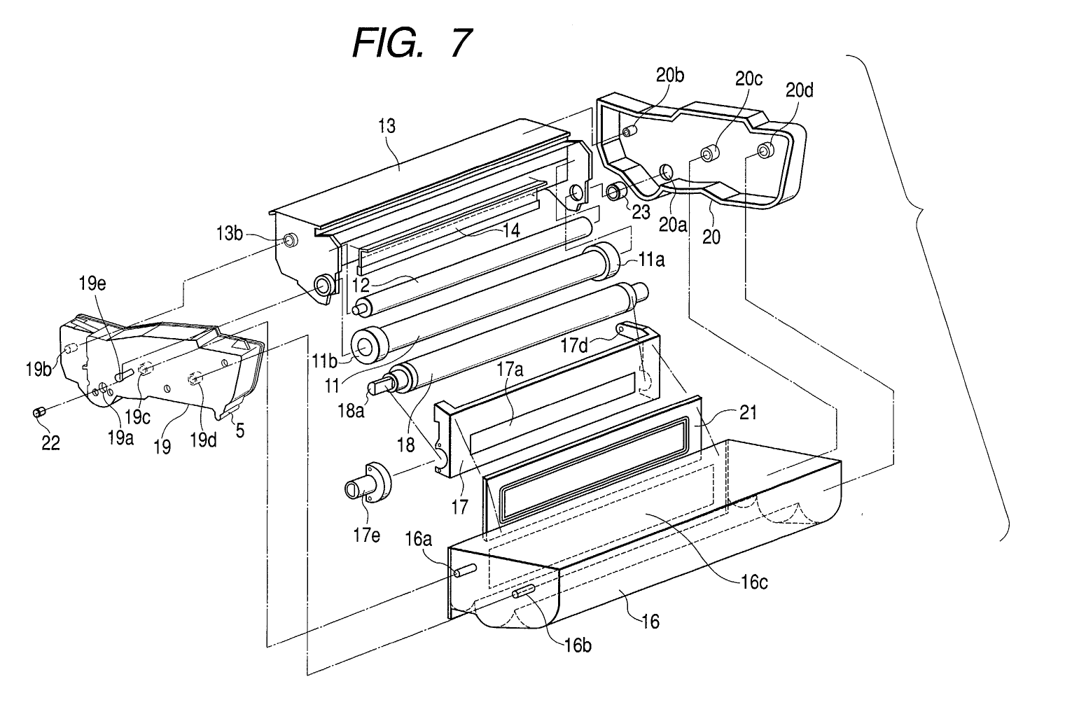

FIG. 1 and FIGS. 3 to 7 are referred while the configuration of the process cartridge 15 is described. FIG. 7 is a perspective view showing the frame configuration of the process cartridge 15 before it is assembled. The process cartridge 15 is chiefly composed of three frame bodies: a cleaning frame body 13 in which the photosensitive body drum 11, the charging roller 12 and the cleaning blade 14 are integrally incorporated; a developing frame body 17 in which the developing roller 18 and the developing blade 26 (not shown in FIG. 7. See FIG. 1) are integrally supported; and the toner containing frame body 16 containing toner T therein. Moreover, side covers 19 and 20 for supporting the three frame bodies 13, 17 and 16 integrally fix them on both the side faces of them to constitute the process cartridge 15.

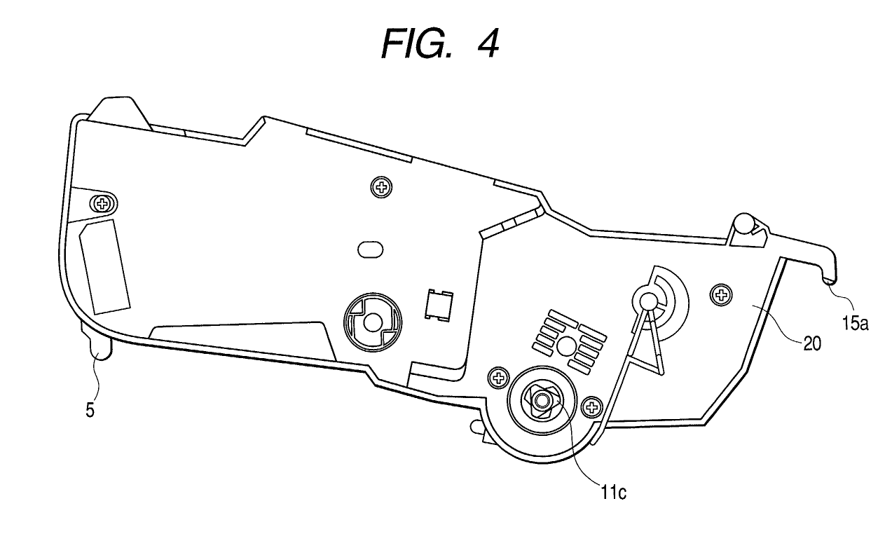

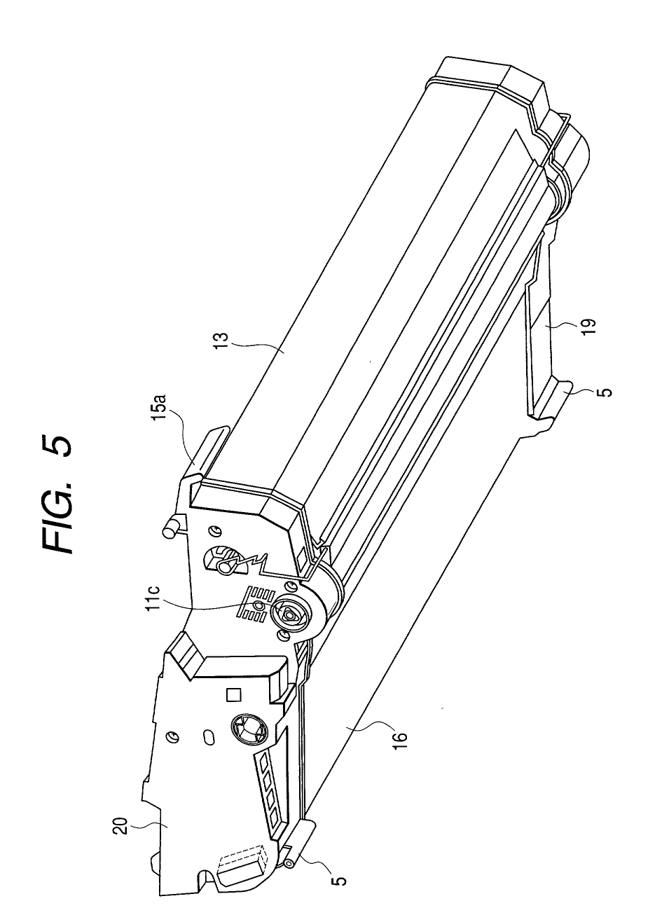

The cleaning frame body 13 fixes the cleaning blade 14 with machine screws or the like thereto, and supports the charging roller 12 rotatably at the core metal portions on both end portions of the charging roller 12 with bearing members (not shown) being put between the cleaning frame body 13 and the charging roller 12. Moreover, the cleaning frame body 13 rotatably supports the photosensitive body drum 11 at flange portions 11a and 11b on both end portions of the photosensitive body drum 11 with bearing members 22 and 23 being put between the cleaning frame body 13 and the photosensitive body drum 11. Incidentally, as shown in FIG. 4 and FIG. 5, the flange portion 11a supports the so-called triangle coupling 11c to engage with a driving coupling of the apparatus main body C at an end portion of the flange portion 11a, and the flange portion 11a is driven from a driving apparatus in the apparatus main body C through the triangle coupling 11c to drive the photosensitive body drum 11. The toner containing frame body 16 contains toner T in its inside together with toner carrying members 27.

The developing roller 18 including a magnet roller 18a, the developing blade 26 and a magnetic seal (not shown in FIG. 7) are disposed in the developing frame body 17. One side end of the magnet roller 18a is supported by a projecting portion 17e being a developing roller bearing of the developing frame body 17 and the other side end thereof is supported by the developing frame body 17, and the magnet roller 18a keeps a gap with the developing roller 18. The developing roller 18 is configured to perform the electric power supply thereto through an electric contact point disposed in the inside of the developing roller 18. Moreover, an anti-climbing roller (not shown) for keeping the interval from the photosensitive body drum 11 constant is provided on the developing roller 18.

The developing frame body 17 is supported by the cleaning frame body 13 swingably around a suspension hole 17d formed on one side face side of the developing roller 18 such that the center of the developing roller 18 goes toward the center of the photosensitive body drum 11.

Moreover, the process cartridge 15 is configured to pressurize the projecting portion 17e, which is fixed on a central axis line of the developing roller 18 in the lengthwise direction thereof on the other side face side of the developing frame body 17, toward the center of the photosensitive body drum 11. The projecting portion 17e is configured to be inserted into a groove 19e (an elongated hole in the shape of a straight line substantially parallel in the center direction of the photosensitive body drum 11 in the present embodiment) formed on the side cover 19 in the state movable to the center direction of the photosensitive body drum 11. Moreover, an elastic member (not shown) is disposed in the inside of the groove 19e such that the elastic body pressurizes the projecting portion 17e to bias the developing roller 18 along the photosensitive body drum 11.

On the other hand, the groove 19e also has the role of a locating hole for regulating the moving direction of the developing roller 18.

When a driving force works on the process cartridge 15, not shown gears, which are respectively provided on the photosensitive body drum 11 and the developing roller 18 and mesh to each other, are designed to receive a force respectively in the direction of interlocking with each other around the suspension hole 17d lest the forces should work in the direction to separate the photosensitive body drum 11 and the developing roller 18 from each other. Moreover, the elastic member provided in the groove 19e also pressurizes the developing roller 18 toward the photosensitive body drum 11 always.

The side cover 19 on one side has a size covering a principal section of the process cartridge 15. The side cover 19 is disposed on one end of the process cartridge 15 in the lengthwise direction. The side cover 19 integrally supports the cleaning frame body 13 and the toner containing frame body 16 by fixing them thereto respectively. A hole portion 19a in the side cover 19 is located on the same axis as that of the center of the photosensitive body drum 11. At this time, if the location of the side cover 19 is performed by the use of the bearing member 22, the location can be determined highly precisely. Moreover, a locating portion 19b formed at a position distant from the photosensitive body drum 11 as far as possible locates the position of side cover 19 in the rotational direction thereof together with a locating portion 13b formed on a side face of the cleaning frame body 13, and the side cover 19 and the cleaning frame body 13 are fixed to each other with several machine screws. Furthermore, the toner containing frame body 16 forms locating portions 16a and 16b on its one end face. The toner containing frame body 16 is located to the side cover 19 by means of the locating portions 16a and 16b and locating portions 19c and 19d disposed on the side cover 19. The toner containing frame body 16 is fixed to the side cover 19 with several machine screws. The side cover 20 on the other side is similarly configured.

Moreover, the bearing member 22 also has the role of a locating member of the process cartridge 15 to the apparatus main body C. Opening portions 16c and 17a are respectively formed in the toner containing frame bode 16 and the developing frame body 17 for the supply of toner from the toner containing frame body 16 to the developing roller 18. The opening portions 17a and 16c in the developing frame body 17 and the toner containing frame body 16 are connected through a seal member 21. Moreover, the toner containing frame body 16 is located by the side covers 19 and 20, the developing frame body 17 is located by the cleaning frame body 13. There is consequently the possibility that distortion is produced in either of the developing frame body 17 and the toner containing frame body 16 owing to dimension errors between them. Accordingly, the seal member 21 is made from a flexible material. In such a configuration, if toner increases in the process cartridge 15, the load owing to the increased toner is imposed on the side covers 19 and 20, and no loads are imposed on the developing roller 18. Consequently, no surplus loads are imposed on the photosensitive body drum 11, and stable images can be obtained. Moreover, because the three frame bodies 13, 17 and 16 are connected to the side covers 19 and 20 on their side faces, the locations of the respective frame bodies 13, 17 and 16 can be determined by means of only the side covers 19 and 20. Consequently, the frame bodies 13, 17 and 16 can precisely be connected to each other.

(Description of Developing Apparatus)

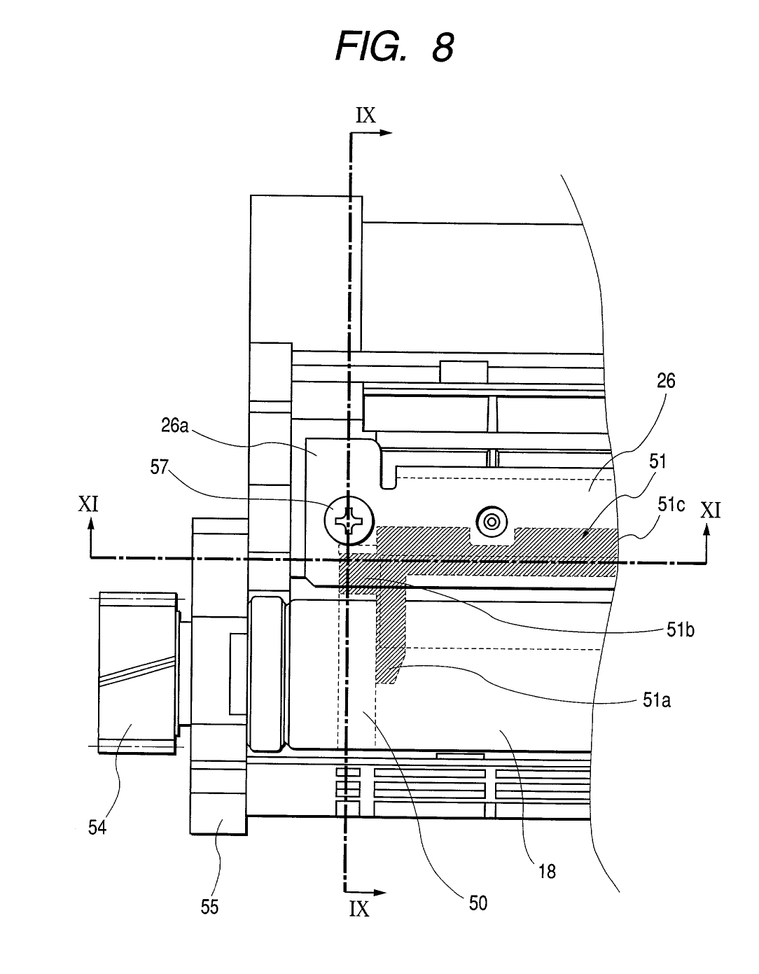

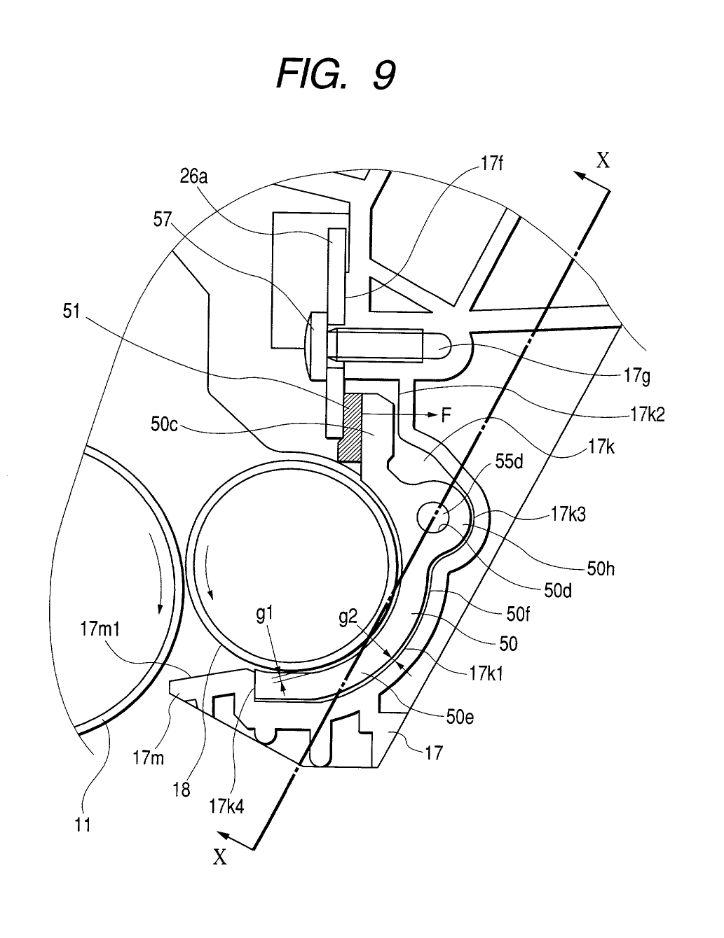

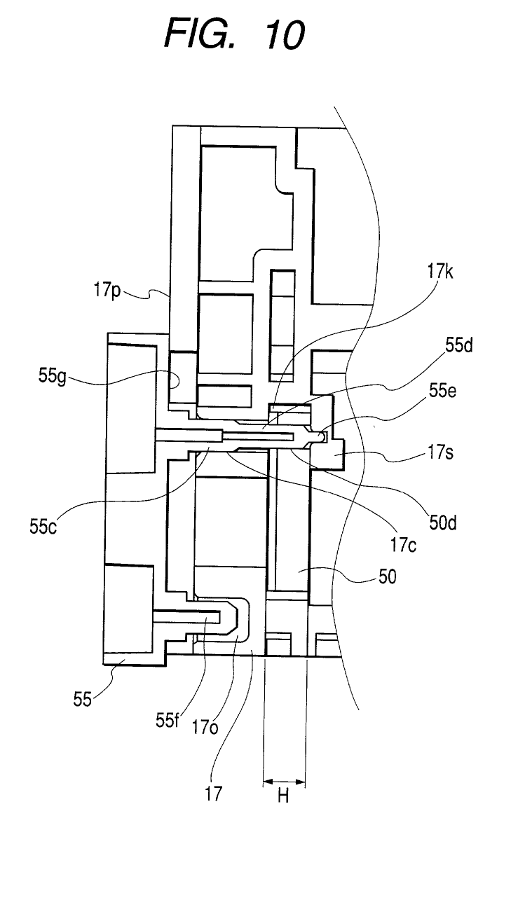

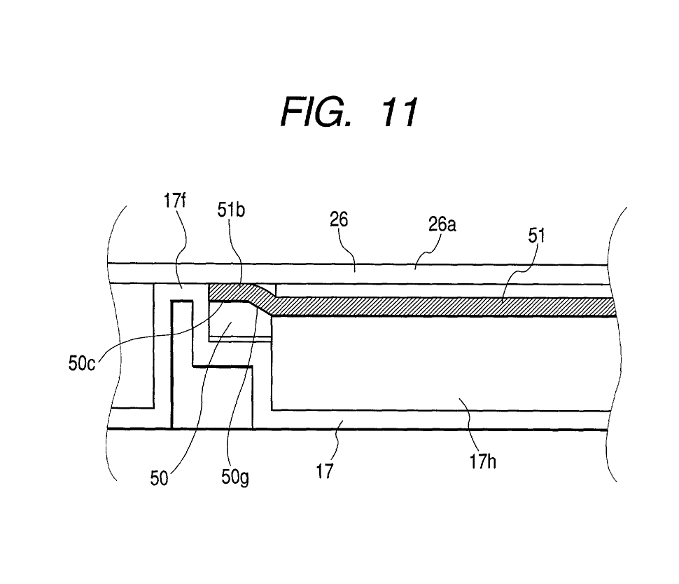

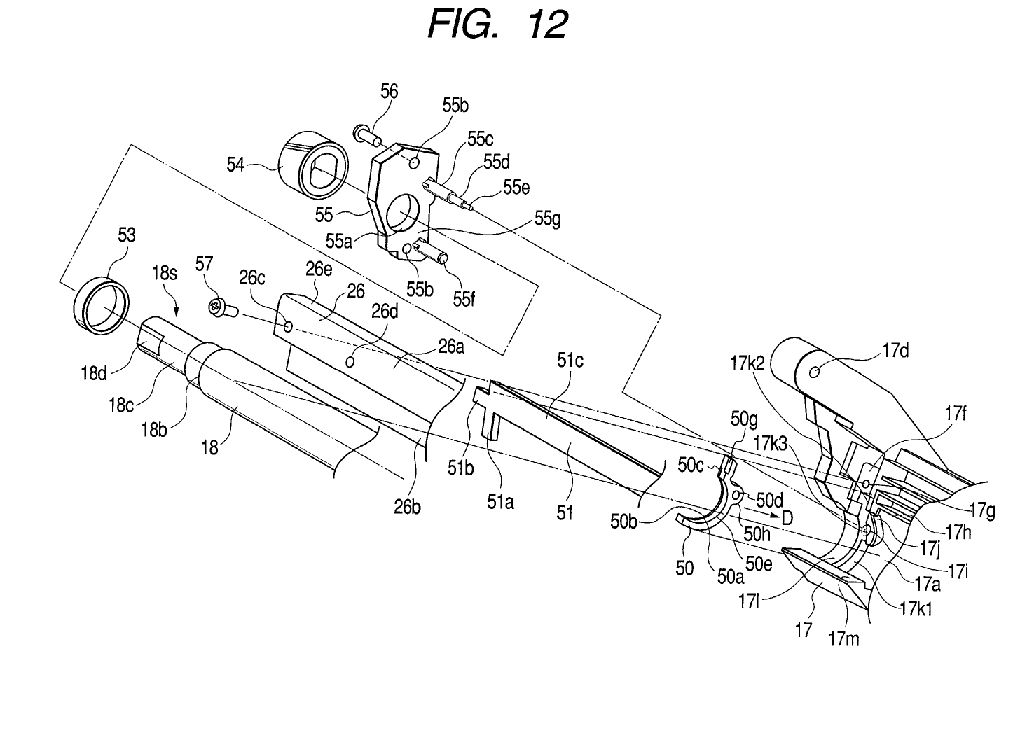

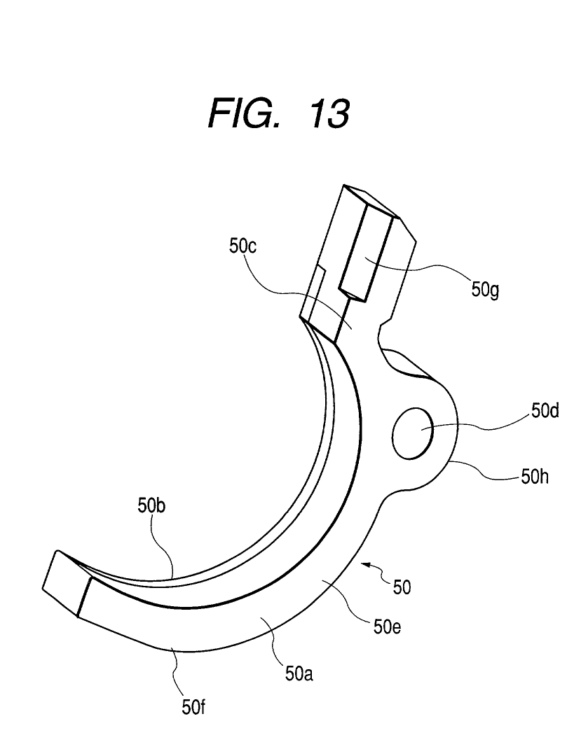

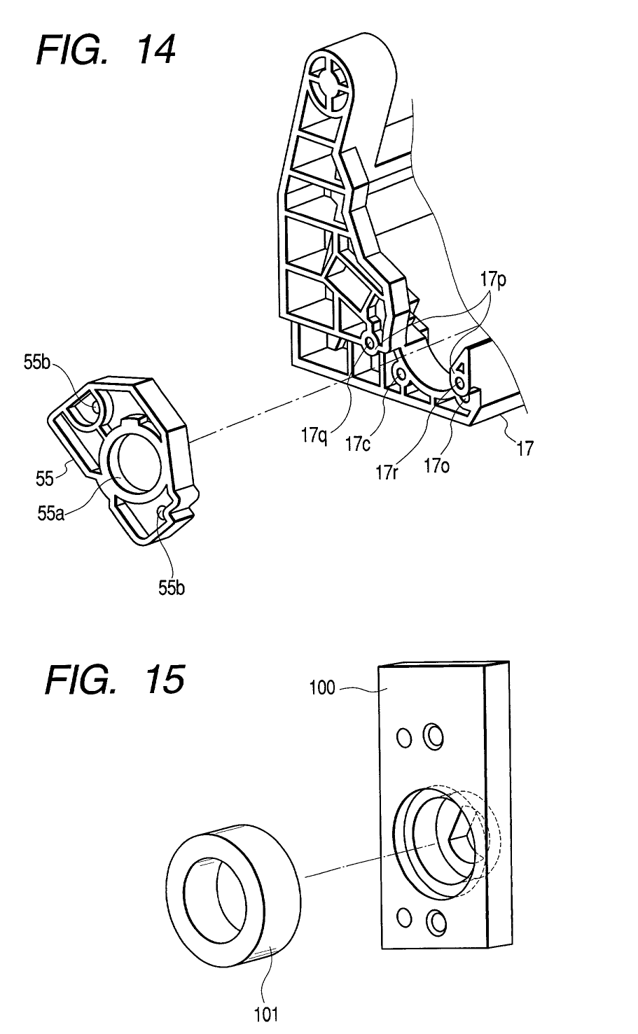

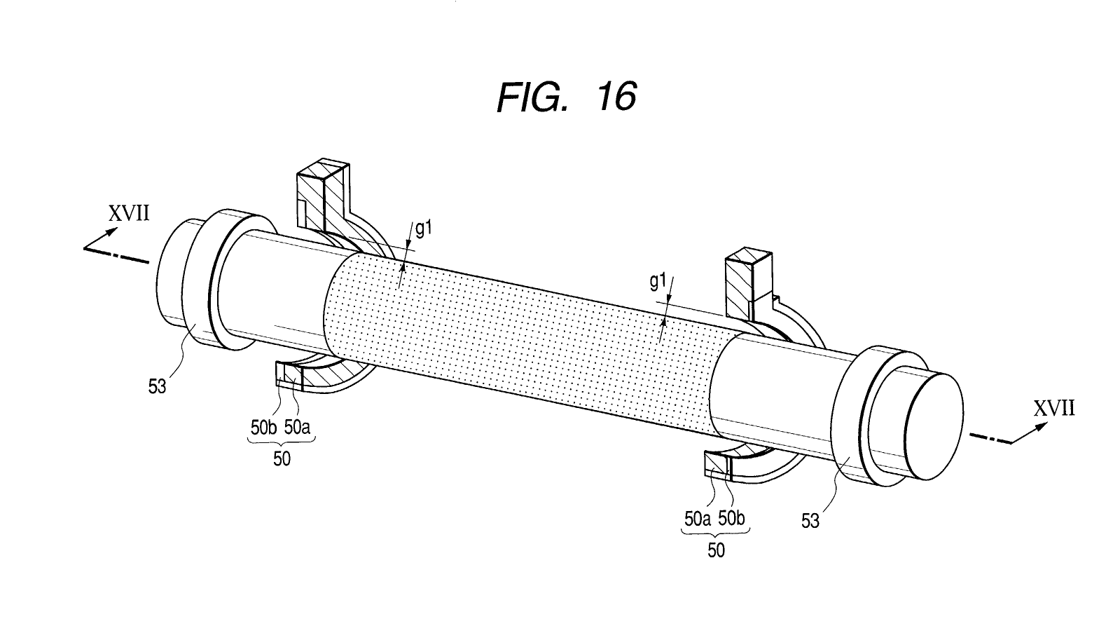

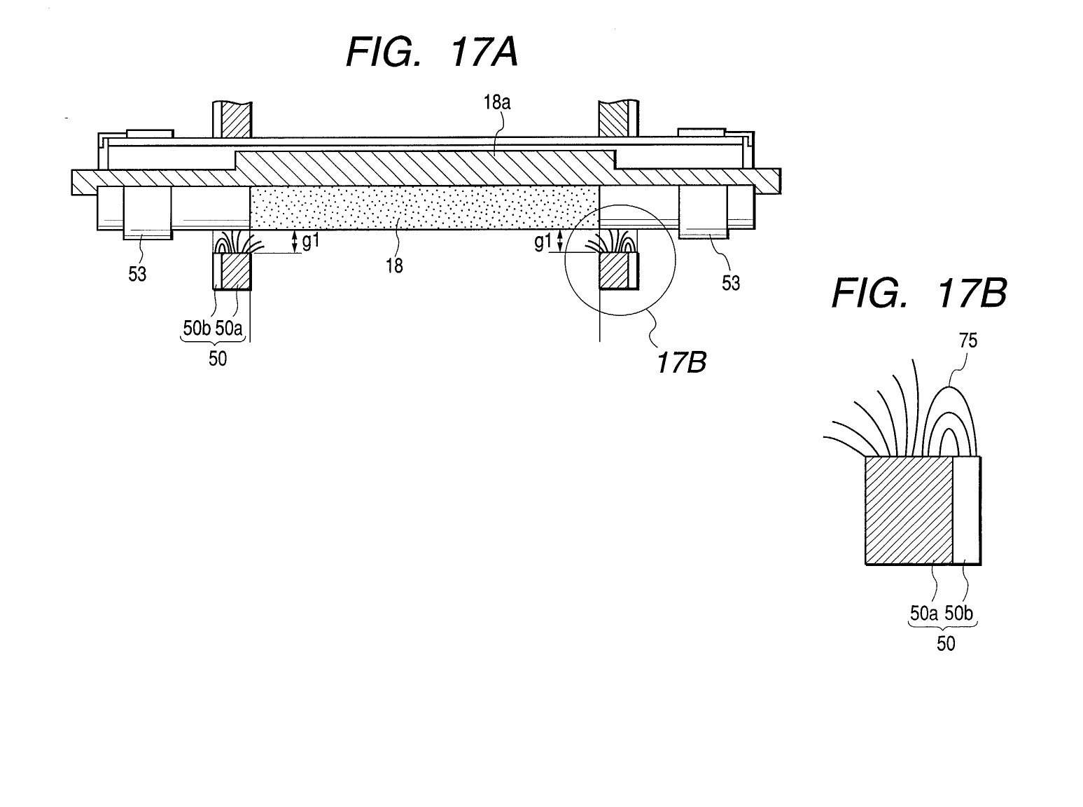

Next, the developing apparatus is described more minutely. FIG. 8 is a plan view of the developing apparatus seen from the direction orthogonal to the lengthwise direction of the developing roller 18. FIG. 9 is a sectional view of the developing apparatus taken along IX-IX line in FIG. 8. FIG. 10 is a sectional view of the developing apparatus taken along X-X line in FIG. 9. FIG. 11 is a sectional view of the developing apparatus taken along XI-XI line in FIG. 8. FIG. 12 is a perspective view showing a state of each part of the developing apparatus before they are assembled. FIG. 13 is a perspective view of a simplex magnetic seal. FIG. 14 is a perspective view showing only a developing bearing frame body and the developing frame body 17 before they are assembled. FIG. 15 is a perspective view of another embodiment of the developing bearing frame body. FIG. 16 is a perspective view showing only a developing roller and a magnetic seal. FIG. 17A is a sectional view of the developing roller and the magnetic seal taken along XVII-XVII line in FIG. 16, and FIG. 17B is a macrograph of the part of 17B in FIG. 17A.

As described above, the developing roller 18 and the developing blade 26 are incorporated into the developing frame body 17 as the components related to image formation.

As shown in FIG. 12, the developing blade 26 is composed of a sheet metal 26a having the thickness of about 1 mm to 2 mm and a polyurethane rubber 26b fixed on the sheet metal 26a by hot melt adhering or with a pressure sensitive adhesive double coated tape or the like. By the contact of the polyurethane rubber 26b with a generating line of the developing roller 18, the quantity of the toner on the peripheral surface of the developing roller 18 is regulated. Incidentally, a silicon rubber may be employed as the developing blade 26. Female screws 17g are provided on anti-climbing planes 17f formed in the developing frame body 17 as blade fitting portions, and dowels (not shown) for location are formed at positions near to the centers of the anti-climbing planes 17f a little. Accordingly, fitting holes 26d formed in the sheet metal 26a are fitted to the dowels (not shown) each other. After that, machine screws 57 are screwed into the female screws 17g through tapped holes 26c to fix the sheet metal 26a to the anti-climbing planes 17f. Thus, the position of the leading edge of the polyurethane rubber 26b is determined, and then the touching pressure of the polyurethane rubber 26b to the developing roller 18 is determined. Consequently, the distance from the leading edge of the polyurethane rubber 26b to the touching position is determined, and the development condition is determined. Moreover, one end of the sheet metal 26a of the developing blade 26 is bent by the angle of about 90 degrees to form a bent portion 26e for the heightening of the rigidity of the sheet metal 26a in order that the polyurethane rubber 26b is touched to the developing roller 18 uniformly in the lengthwise direction of the developing roller 18.

Incidentally, an elastic seal member 51, which is made from a moltopren (trade name) or the like and is formed in a shape of substantially a letter U, is stuck to the developing frame body 17 along its elastic seal seat surface 17h (see FIG. 12) at the upper part of the opening portion 17a in the lengthwise direction and its seat surfaces 17j in the widthwise direction for the prevention of the leakage of toner to the outside. A first straight line portion 51c of the elastic seal member 51 is stuck to the seat surface 17h of the developing frame body 17, and second straight line portions 51a of the seal member 51 are stuck to the seat surfaces 17j. The elastic seal member 51 is put between the developing frame body 17 and the developing blade 26 to be pinched out by them, and thereby the leakage of toner is prevented. Lug portions 51b are formed on the elastic seal member 51 at both end portions thereof to project from the end portions in the lengthwise direction of the seal member 51 by several millimeters. The lug portions 51b perform the role of locating the magnetic seal 50, which will be described later.

Moreover, as shown in FIG. 9 and FIG. 12, the magnetic seals 50 are attached to grooves 17k formed on the surfaces adjoining (at the insides of arc surfaces 17l in the lengthwise direction of the developing roller 18) to the arc surfaces 17l and flat surfaces continuing upward from the arc surfaces 17l along the peripheral direction of the developing roller 18 at both end portions of the opening portion 17a in the lengthwise direction of the developing roller 18. The magnetic seals 50 will be described later in detail.

Furthermore, a thin film elastic seal member (not shown), which abuts on a generating line of the developing roller 18, is stuck to a seat surface 17m1 in the upper part of a lower jaw portion 17m of the developing frame body 17.

The developing roller 18 is a cylindrical member made of a metal material of aluminum, stainless steel or the like. The outer diameter of the cylindrical shape of the developing roller 18 is about 16 mm to 20 mm, and the thickness of the cylindrical shape is about 0.5 mm to 1 mm. A surface treatment such as carbon coating, abrasive blasting or the like is performed to the surface of the developing roller 18 for the heightening of the electrification characteristic of developer. Only the carbon coating is performed in the present embodiment.

Sleeve flanges (only one end portion of them is shown in FIG. 12) 18s, which are stepped cylindrical members made of a metal material of aluminum, stainless steel or the like, are force-fitted into both end portions of the developing roller 18. Each of the sleeve flanges 18s is coaxial with the developing roller 18, and is composed of a first cylindrical portion 18b and a second cylindrical portion 18c, the outer diameters of which are smaller in the order. The first cylindrical portion 18b is provided with a spacer roller 53 being a ring-shaped distance regulating member for regulating the opposed distance between the developing roller 18 and the photosensitive body drum 11. The space roller 53 is made from an insulating material such as polycetal or the like. A developing bearing frame body 55 (its especially enlarged perspective view seen from the reverse side is shown in FIG. 14) for supporting the developing roller 18 rotatably and locating it to the developing frame body 17 is disposed around the second cylindrical portion 18c. Moreover, two flat surfaces 18d are formed at the tip portion of the second cylindrical portion 18c, and a developing roller gear 54 made from a synthetic resin is fitted to the cylindrical portion 18c having the flat surfaces 18d. The developing roller gear 54 is driven by a helical drum gear (not shown) provided at an edge portion of the photosensitive body drum 11 to rotate the developing roller 18. The helical teeth of the drum gear are twisted such that the thrust thereof in the axial direction thereof works in the lengthwise direction of the developing roller 18. Moreover, a magnet roller (designated by a reference numeral 18a in FIG. 17A) for make toner adhere to the peripheral surface of the developing roller 18 is built in the developing roller 18. Because the sleeve flange on the other end portion of the developing roller 18 has a similar configuration, the descriptions thereof is here omitted. The developing bearing frame body 55 is made from a resin material producing a good slidable property, and is shaped to be a flat plate having a thickness of about 2 mm to 5 mm. At approximately the center of the flat plate portion, a cylindrical bearing portion 55a is formed. The inner diameter of the bearing portion 55a is 8 mm to 15 mm. The bearing portion 55a fits to the second cylindrical portion 18c of the sleeve flange 18s, and thereby the developing roller 18 slides therein while rotating. Moreover, a dowel 55c including a first step portion 55d, and a second step portion 55e at its end portion, both being for locating the developing bearing frame body 55 against the developing frame body 17, is formed on the surface 55g of the flat plate portion of the developing bearing frame body 55 in substantially parallel to the bearing portion 55a. The dowel 55c performs the role of locating the developing bearing frame body 55 against the developing frame body 17. The first step portion 55d and the second step portion 55e, both being coaxial with the dowel 55c at the end portion of the dowel 55c, is used for the location of the magnetic seal 50, which will be described later. Moreover, on the same surface 55g, tapped holes 55b for the fixation of the developing bearing frame body 55 to the developing frame body 17 with machine screws 56 or the like, and a dowel 55f for the location of the developing bearing frame body 55 to the developing frame body 17 are formed. The dowel 55c of the developing bearing frame body 55 is fitted into a location hole 17c (shown in FIG. 14) formed in the developing frame body 17, and the dowel 55f is fitted into a fitting elongated hole 17o formed in e developing frame body 17, and further the surface 55g of the developing bearing frame body 55 is touched to a surface 17p of the developing frame body 17. Then, the machine screws 56 are screwed into female screws 17q and 17r formed on the developing frame body 17 through the two tapped holes 55b, and the developing bearing frame body 55 is fixed to the developing frame body 17. Thereby, the positions of the developing blade 26 and the developing roller 18, both being fixed to the developing frame body 17, are surely determined, and stable images can be outputted.

Because the developing roller 18 slides in the bearing portion 55a of the developing bearing frame body 55 mentioned above, the material of the developing bearing frame body 55 is preferably a comparatively high priced material having a good sliding property (for example, a bearing material based on poly phenylene sulfide (PPS) or polyamide (PA)). Accordingly, as shown in FIG. 15, if only a bearing portion is separated from a housing 100 as a bearing bushing 101, the quantity of the expensive material to be used is not needed so much, and the housing 100 can be made from a comparatively cheap material such as high-impact polystyrene (HIPS).

(Magnetic Seal)

The magnetic seal 50 (shown in an especially enlarged figure in FIG. 13) is an injection-molded article having a width of 3 mm to 4 mm. A magnet 50a being a component of the magnetic seal 50 includes Nd—Fe—B magnetic power with a nylon binder. A magnetic plate 50b being another component of the magnetic seal 50 is made from iron and has a thickness of 1 mm to 1.5 mm. The magnet 50a and the magnetic plate 50b are molded by the insert molding such that the magnetic plate 50b is embedded in the magnet 50a except for the remaining inner periphery and the outside side face of the magnet 50. However, the joining by an adhesive, the joining by a pressure sensitive adhesive double coated tape, or the attraction joining only by a magnetic force can similarly bring about the advantages that will be described later. Moreover, the gap between the developing roller 18 and the magnetic seal 50 is 0.1 mm to 0.7 mm, and the magnetic flux density on the surface of the developing roller 18 owing to the magnetic force of the magnetic seal 50 in this case is about 1,000 Gs to 2,000 Gs. Then, as shown in FIG. 16, in the state such that two magnetic seals 50 are fixed to the developing frame body 17, the magnets 50a of the two magnetic seals 50 are located to be opposed to each other.

By the disposition of the two magnetic seals 50 in the way described above, the lines of magnetic forces 75 of each of the magnetic seals 50 are formed between the magnet 50a and the magnetic plate 50b to enter into the magnetic plate 50b having a higher permeability as shown in FIG. 17B, which is a macrograph of the part of 17B in FIG. 17A. Consequently, no lines of magnetic forces expand to the outside of the width of the magnetic seal 50.

Consequently, no toner diffusing along the lines of magnetic forces 75 on the surface of the magnetic seal 50 exists on the outside of the magnetic plate 50b on the side of the magnetic plate 50b (or the outside of the opening portion 17a). The phenomenon such that toner is touched to the spacer roller 53 being a distance regulating member owing to the rotations of the developing roller 18 does not happen. Consequently, the spacer roller 53 can be approached to the side face of the magnetic seal 50, and thereby naturally the process cartridge 15 can be miniaturized, and the apparatus main body C can also be miniaturized.

Moreover, because the toner on the magnetic seal 50 does not diffuse to the outside of the opening portion 17a of the developing frame body 17 from the magnetic plate 50b, the toner can securely be held within a range where the magnetic force on the surface of the magnetic seal 50 is strong. Consequently, a good seal property such that toner does not leak out even if impact or the like is imposed on the process cartridge 15 when a user attaches or detaches the process cartridge 15 to the apparatus main body C can be obtained.

Moreover, the fact that the lines of magnetic forces 75 enter into the magnetic plate 50b by the disposition of the magnetic plate 50b on the side face of the magnet 50a is to converge the lines of magnetic forces 75, which has the tendency of divergence, into the magnetic plate 50b. Consequently, the magnetic flux density on the surface of the magnet 50a becomes large, which makes the magnetic force of the magnet 50 large. Hence, it is achieved to improve the sealing property furthermore. Besides, because a cheap magnet, which has a small magnetic force, can be used if the sealing property is not needed so strictly, the cost of the process cartridge 15 can be decreased.

(Location Configuration of Magnetic Seal)

The magnetic seal 50 is located to the developing roller 18 by means of the developing frame body 17, the elastic seal member 51 and the developing bearing frame body 55, all being described above. That is, the magnetic seal 50 is located by the location to a location hole 50d of the magnetic seal 50 shown in FIG. 9 and by the biasing of the magnetic seal 50 in the rotation direction around the location hole 50d. The location is described on the basis of FIG. 8, FIG. 9, FIG. 10, FIG. 11 and FIG. 13 in detail.

As shown in FIG. 9, both the magnet 50a and the magnetic plate 50b have a half arc portion 50e (or the half arc portion of the magnetic seal 50), the inner periphery side of which forms a gap g1 with the developing roller 18, and an end face portion 50c, which offsets to the side of he developing frame body 17 halfway on the half arc portion 50e to extend upward in a straight line from the upper part of he half arc portion 50e. The cross section of the magnet 50a is nearly a square, and the cross section of the magnet 50a combined with the magnetic plate 50b is a square. An arc-shaped bending portion 50h projects towards the outside in the radial direction from the outer periphery 50f of the magnet 50a, and the location hole 50d is exists at the center of the arc of the bending portion 50h. As shown in FIG. 13, the upper end of the magnetic plate 50b is fitted into the end face portion 50c, and the magnet 50a and the magnetic plate 50b form the same plane on the outside side face of the magnetic seal 50 in the lengthwise direction.

As shown in FIG. 9 and FIG. 12, a groove 17k (17k1, 17k2 and 17k3) for the attachment of the magnetic seal 50 is formed from the anti-climbing plane 17f, to which the developing blade 26 is attached, to an adjoining position to the arc surface 171 along an end portion of the developing roller 18. The groove 17k is composed of an arc groove 17k1 along the arc of the arc surface 171 (see FIG. 12), a straight line groove 17k2 along the anti-climbing plane 17f in a vertical direction, and a location groove 17k3, in which the bending portion 50h (the inner periphery of which forms the location hole 50d) of the magnetic seal 50 is just fitted. These grooves 17k1, 17k2 and 17k3 are continuously formed. The location groove 17k3 is recessed from the base of the arc groove 17k1. The width H (noted in FIG. 10) of the groove 17k and the width of the magnetic seal 50 are formed to be the same. And, the magnetic seal 50 is fitted into the groove 17k. Thereby, the position of the magnetic seal 50 to the developing roller 18 in the lengthwise direction of the developing roller 18 is determined. Moreover, the depth of each portion of the groove 17k for the attachment of the magnetic seal 50 thereto is deeper than the thickness of each corresponding portion of the magnetic seal 50 by 0.1 mm to 0.7 mm when the magnetic seal 50 is fitted into a predetermined position (the fitting will be described later). That is, the surface of the outer periphery 50f of the magnetic seal 50 keeps a gap g2 (see FIG. 9) from the groove 17k of the developing frame body 17. For the prevention of the leakage of toner through the gap g2, a magnetic pole is disposed on the surface of the outer periphery 50f of the magnetic seal 50 as a magnetic pole is disposed on the surface opposed to the developing roller 18, and the leakage of toner to the outside can be prevented by the magnetic force caused by the magnetic pole. Moreover, the magnetic seal 50 may be configured such that the magnetic plate 50b is extended to the surface of the outer periphery 50f to prevent the leakage of the magnetic force to the outside likewise on the developing roller 18 side for heightening the effect of the magnetic force.

Next, the location of the magnetic seal 50 is described in detail. As shown in FIG. 10, the first step portion 55d at the end of the dowel (or a shaft) 55c projecting from the developing bearing frame body 55 described above is fitted into the location hole 50d of the magnetic seal 50, and thereby the magnetic seal 50 is rotatably supported around the first step portion 55d. Moreover, the second step portion 55e at the end of the fist step portion 55d is fitted into a location hole 17s, which is coaxial with the location hole 17c of he developing frame body 17 and is formed on the side opposed to the groove 17k. Thereby, both the end faces of the magnetic seal 50 are supported. Because the magnetic seal 50 is supported at both the end faces, even if the shaft for location is slender in some degree, the magnetic seal 50 can be supported with a sufficient strength. Thereby, the space of the magnetic seal 50 can be reduced. Furthermore, although the dowel 55c being a location shaft easily falls in its formation process by molding, it is comparatively attained by molding to locate the center positions of the location holes 17c and 17s of the developing frame body 17 on the same axis precisely. Consequently, the location of the magnetic seal 50 can precisely be performed.

Next, the location of the magnetic seal 50 in its rotation direction is, as shown in FIG. 9, performed by the contact thereof to a lower end face 17k4 of the arc groove 17k1 of the developing frame body 17, i.e. an end face 17k4 falling down from the seat surface 17m1 with an elastic seal (not shown) at the lower jaw portion 17m described above. Moreover, a biasing force F for contacting the magnetic seal 50 to the end face 17k4 surely is caused by a repulsive force generated by the compression of mainly the lug portion 51b (see FIG. 12) of the elastic seal member 51 lying between the portion of the end face 50c in a straight line at the upper part of the magnetic seal 50 and the sheet metal 26a of the developing blade 26. Thus the biasing force F works on the magnetic seal 50 in the clockwise direction around the location hole 50d, and thereby the magnetic seal 50 is surely located to the developing roller 18. Moreover, only the developing bearing frame body 55 exists between the magnetic seal 50 and the developing roller 18, and consequently the dispersion of the length of the gap g1, which generally becomes large by the accumulation of tolerances, is suppressed to be as small as possible. Consequently, the allowance for the leakage of toner can be improved. Moreover, although the gap g1 has conventionally been measured during a manufacturing process, the examination of the gap g1 becomes unnecessary because the accumulation of tolerances becomes small. Moreover, the biasing force F is produced by means of a part of the elastic seal member 51, and thereby the location of the magnetic seal 50 can surely be performed at low cost without surplus parts. Furthermore, the elastic seal member 51 uses an insulating material, and thereby the elastic seal member 51 also performs the role of preventing leakage of a voltage when a high voltage is not desired to be applied to the sheet metal 26a of the developing blade 26, for example.

Next, the assembly of the magnetic seals 50 until their positions are determined is described on the basis of FIG. 12.

As shown in FIG. 12, the magnetic seals 50 are brought into the grooves 17k of the developing frame body 17 for the attachment of the magnetic seals 50 as indicated by an arrow D. Then, the half arc portions 50e of the magnetic seals 50 are fitted into the arc grooves 17k1, and the end face portions 50c are fitted into the straight line grooves 17k2. After that, the magnetic seals 50 are pushed into the arc grooves 17k1 and the straight line grooves 17k2 until the inner peripheral surfaces of the half arc portions 50e are at substantially the same heights as those of the arc surfaces 17l. Next, the first straight line portion 51c of the elastic seal member 51 is stuck to the elastic seat surface 17h being the end face of a rib of the developing frame body 17 in the lengthwise direction, and the second straight line portions 51a are stuck to the seat surfaces 17j of the developing frame body 17. And further, the lug portions 51b are stuck to the end face portions 50c of the magnetic seal 50. At this time, because the heights of the elastic seal seat surface 17h and the magnetic seal 50 are different from each other, the elastic seal member 51 is not easy to stick (see FIG. 11). For making it easy to stick the elastic seal member 51, a tapered plane 50g (shown in FIG. 13) is formed. Moreover, the lug portions 51b and the second straight line portions 51a may be formed to be separate bodies in view of material allotting. As for the incorporation of the developing blade 26, as described above, the fitting holes 26d formed in the sheet metal 26a are fitted to the dowels (not shown) each other. After that, the machine screws 57 are screwed into the female screws 17g through the tapped holes 26c formed in the sheet metal 26a to fix the sheet metal 26a to the anti-climbing planes 17f. Next, the unit of the developing roller 18 is temporarily put in the developing frame body 17 to be coaxial with the half arc portions 50e of the magnetic seals 50. At this time, the developing roller 18 does not directly contact with the magnetic seals 50 owing to the repulsive force of the polyurethane rubber 26b of the developing blade 26, and consequently the surface of the developing roller 18 is not injured by the magnetic seals 50.

Lastly, the developing bearing frame bodies 55 are assembled from both side face sides of the developing frame body 17 (though FIG. 12 shows one end side of the developing frame body 17, the other end side thereof is in the same configuration). That is, as described above by reference to FIG. 14, the dowels 55f are fitted into the fitting elongated holes 17o (which are elongated in the up and down direction in parallel to the surface of the sheet of FIG. 10), and further the surfaces 55g of the developing bearing frame bodies 55 are touched to the surfaces 17p of the developing frame body 17. Then, the machine screws 56 are screwed into the female screws 17q and 17r formed on the surfaces 17p through the tapped holes 55b formed in the developing bearing frame bodies 55, and the developing bearing frame bodies 55 are fixed to the developing frame body 17. Thereby, the magnetic seals 50 are located around the first step portions 55d in the states of being able to tilt. The magnetic seals 50 receive moments around the first step portions 55d by forces biased by the repulsive force of the elastic seal member 51 lying between the magnetic seals 50 and the developing blade 26, and the lower end faces of the magnetic seals 50 are touched to the lower end faces 17k4 of the grooves 17k of the developing frame body 17.

As described above, the positions of the magnetic seals 50 to the developing roller 18 are surely determined by a simple assembling method.

The present invention is not bounded to the aforesaid embodiments, and many modifications within the scope of the technical concepts of the present invention can be included therein.

What is claimed is:

1. A developing apparatus comprising:
a rotatable developer bearing member;
a bearing member for holding said developer bearing member rotatably; and
a seal member for preventing a leakage of a developer from an end portion of said developer bearing member in a lengthwise direction thereof to the lengthwise direction,
wherein said seal member is located by said bearing member.

2. A developing apparatus according to claim 1, wherein said seal member is disposed along a peripheral surface of the end portion of said developer bearing member in the lengthwise direction thereof.

3. A developing apparatus according to claim 1, wherein said bearing member includes a shaft for locating said seal member rotatably, and said seal member includes a hole to which said shaft is fitted.

4. A developing apparatus according to claim 3, further comprising locating means for determining a position of said seal member in a rotation direction thereof around said shaft.

5. A developing apparatus according to claim 4, wherein said locating means includes biasing means for biasing said seal member in the rotation direction, and a receiving portion for receiving said seal member biased by said biasing means.

6. A developing apparatus according to claim 5, further comprising a regulating member for regulating a quantity of the developer to be borne by said developer bearing member, and an elastic member provided between said regulating member and said seal member, wherein said regulating member and said elastic member work as said biasing means.

7. A developing apparatus according to claim 6, wherein said elastic member has an insulating property.

8. A developing apparatus according to claim 6, wherein said elastic member is a foam urethane.

9. A developing apparatus according to claim 1, wherein said seal member is a part to be attached to a main body of said developing apparatus from a direction crossing with the longwise direction, and said bearing member is a part to be attached to said main body from a direction parallel to the lengthwise direction.

10. A developing apparatus according to claim 3, wherein, when said bearing member is attached to a main body of said developing apparatus, said shaft passes through a first hole formed in said main body, and next passes through said hole of said seal member, and further enters into a second hole formed on said main body.

11. A developing apparatus according to claim 10, wherein said shaft is a stepped shaft an end portion of which is slender.

12. A developing apparatus according to claim 1, wherein said seal member magnetically prevents the developer from leaking.

13. A developing apparatus according to claim 1, wherein said developing apparatus is provided in a process cartridge that includes at least a photosensitive body and is detachably attachable to an image forming apparatus.
